(19) United States
(12) Patent Application Publication
(10) Pub. No.: US 2025/0321207 A1
(43) Pub. Date: Oct. 16, 2025

(54) Chromatography

(71) Applicant: Nova Laboratories Ltd, Wigston (GB)

(72) Inventors: Andrew Richard Russell Prewer, Wigston (GB); William Lennard, Wigston (GB); Marco Maurizio Daniele Cominetti, Wigston (GB)

(21) Appl. No.: 19/249,849

(22) Filed: Jun. 25, 2025

Related U.S. Application Data
(63) Continuation-in-part of application No. 16/967,307, filed on Aug. 4, 2020, now Pat. No. 12,357,925.

(30) Foreign Application Priority Data
Feb. 5, 2018 (GB) 1801842.4

(51) Int. Cl. G01N 30/02

(52) U.S. Cl. CPC G01N 30/02; G01N 2030/027

(57) ABSTRACT

A method of removing a chemical entity from a liquid by passing an elongate body through one or more conduits to remove a chemical entity from a liquid. Each of the one or more conduits includes a liquid input port and a liquid outlet port. The liquid from which the chemical entity is removed passes along the one or more conduits from the liquid input port to the liquid output port in the opposite direction to the elongate body, the one or more conduits being configured such that the liquid contacts the elongate body. The method further includes washing the elongate body to remove products other than the chemical entity.

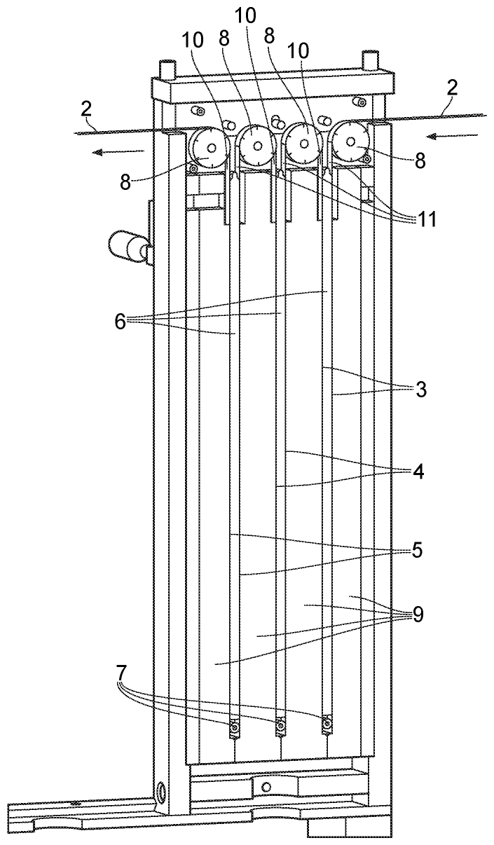

### CROSS-REFERENCE TO RELATED APPLICATIONS

This application is a continuation-in-part of U.S. patent application Ser. No. 16/967,307 filed 4 Aug. 2020, which U.S. patent application Ser. No. 16/967,307 is the National Stage of International Application No. PCT/GB2019/050302 filed 5 Feb. 2019, which International Application No. PCT/GB2019/050302 claims benefit under 35 USC § 119 of GB Application No. 1801842.4 filed 5 Feb. 2018, all applications of which are incorporated herein by reference in their entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

This invention relates to a method of removing, isolating, or purifying a chemical entity from a liquid using chromatography. The method involves passing an elongate solid phase through a conduit through which the liquid also flows.

### 2. Description of Related Art

Biomolecules such as proteins, nucleic acids, antibodies, peptides and oligosaccharides are highly versatile biological materials with applications in medicine, testing and industrial processing. The new generation of biologic pharmaceuticals has produced a variety of novel therapies for many serious diseases that were previously considered hard or impossible to treat. These proteins and antibodies are typically produced in sterile fermenters using cells fed on inexpensive nutrients such as sugars and amino acids. Alternative methods of producing proteins have also been developed through the use of genetically modified plants and animals. Although the actual production of the materials using cell cultures, plants or animals is efficient, it has the drawback that the product is obtained in a dilute aqueous solution combined with a large amount of cellular by-products. This means that the actual purification of the raw material typically accounts for about 80% of the production cost.

The main method for purifying proteins and antibodies uses a technique called ‘affinity chromatography’. This uses a solid material that has been engineered to adsorb specifically the desired material. In this process the cellular mixture is mixed with the solid, and then the solid is separated, washed, and finally treated with a solution that displaces the protein from the solid so it can be collected in the liquid for further processing.

High outputs are often only achieved when batch process affinity chromatography are performed on a large scale. It also suffers from long cycle times and is plant intensive. The need for larger equipment means that hold times are extended, meaning that some products may degrade during manufacture leading to increased impurities and/or lowered yields. The development and validation of large scale chromatography processes is also expensive and time consuming.

Proteins, for example, are often produced by fermentation. The volumes of liquid produced during the fermentation stage of protein production are large, and traditional affinity chromatography processes may require that the fermentation broth is concentrated considerably before the affinity chromatography process. This can harm the desired product and often still results in flow rates for the process that are much larger for the first loading stage than the subsequent elution and/or washing stages.

Multi-column continuous purification methods have been developed but these require complex valves and controls to work. They also have the draw back that large volumes of stationary phase need to be used in parallel columns.

Generally, chromatography is a well-known technique for separating compounds in a solution. Many such techniques, including those discussed below will be apparent to the person skilled in the art. There is a need to improve all known chromatography methods.

### BRIEF SUMMARY OF THE INVENTION

In accordance with the present inventions there is provided a method of removing a chemical entity from a liquid: the method comprising:
a) passing an elongate body through one or more conduits, the conduit comprising a liquid input port and a liquid outlet port; wherein the liquid from which the chemical entity is removed passes along the conduit from the liquid input port to the liquid output port in the opposite direction to the elongate body, the one or more conduits being configured such that the liquid contacts the elongate body; and
b) washing the elongate body to remove products other than the chemical entity.

In embodiments of the invention the method may be method of affinity chromatography wherein the method comprises:
a) passing an elongate body through a conduit, the conduit comprising a liquid input port and a liquid outlet port; wherein the liquid from which the chemical entity is removed passes along the conduit from the liquid input port to the liquid output port in the opposite direction to the elongate body, the conduit being configured such that the liquid contacts the elongate body; wherein attached to the elongate body is an affinity entity, the affinity entity having an affinity for the chemical entity;
b) washing the elongate body to remove products present having lower affinity for the affinity entity than the chemical entity.

In alternative embodiments of the invention the method may be a method of ion exchange chromatography (IEC), hydrophobic interaction chromatography (HIC), reverse phase chromatography, hydrophilic interaction liquid chromatography (HILC), normal phase chromatography or any other suitable type of chromatography. In these chromatography techniques the same technique is used as for affinity chromatography but it may be advantageous that it is necessary to pass the elongate body through a plurality of conduits in the or each stage, in one or more stages the plurality of conduits having a gradient of the relevant property, for example polarity. The plurality of conduits may comprise two, three, four, five, eight, ten or more conduits. This may be necessary as the binding of the species on the stationary phase may be considerably weaker than in affinity chromatography. Thus in embodiments of the invention the elongate body may pass through a plurality of conduits to progressively elute different components of the liquid. The output of each conduit, with a fractionated product, may then be collected. The collected fractionated product may then be collected or fed into downstream systems for further recovery, resolution improvement, or to improve the purity of the product, with either the same or a different chromatographic technique. For example, the collected fractionated product may be fed further processed by a method of chromatography according to the present invention. The elongate member may then be washed and re-equilibrated to loop into an initial conduit.

As set out above, the method of the present invention may be implemented to carry out a variety of chromatography techniques. These include but are not limited to the following chromatography methods:

Ion exchange chromatography: this relies on an interaction between the charges on a solid support phase and the charges on compounds to separate the components of a mixture. It is broadly classified in cation exchange and anion exchange, depending on the charge of the species that interact with the stationary phase.

In methods of ion exchange chromatography the method of the present invention may comprise:
a) passing an elongate body through a plurality of conduits to immobilize a target compound, the plurality of conduits comprising a liquid input port and a liquid outlet port; the plurality of conduits being configured such that the liquid contacts the elongate body;
b) passing the elongate body through a plurality of conduits to wash the immobilized target compound, the plurality of conduits comprising a liquid input port and a liquid outlet port; the plurality of conduits being configured such that the liquid contacts the elongate body;
c) passing the elongate body through a plurality of conduits to collect the immobilized target compound, the plurality of conduits comprising a liquid input port and a liquid outlet port, wherein the plurality of conduits have a stepwise gradient of a buffer;
d) passing the elongate body through a plurality of conduits to clean the elongate body, the plurality of conduits comprising a liquid input port and a liquid outlet port, to wash the elongate body with a buffer; and
e) passing the elongate body through a plurality of conduits to equilibrate the elongate body with an initial buffer, the plurality of conduits comprising a liquid input port and a liquid outlet port.

Hydrophobic interaction chromatography: the separation of different components of a mixture is achieved on the basis of their relative hydrophobicity. High ionic strength drives the interaction between hydrophobic regions of the compound of interest with the hydrophobic stationary phase.

In methods of hydrophobic interaction chromatography the method of the present invention may comprise:
a) passing an elongate body through a plurality of conduits to load a target compound, the plurality of conduits comprising a liquid input port and a liquid outlet port; the plurality of conduits being configured such that the liquid contacts the elongate body;
b) passing the elongate body through a plurality of conduits to elute the target compound, the plurality of conduits comprising a liquid input port and a liquid outlet port; the plurality of conduits being configured such that the liquid contacts the elongate body, the plurality of conduits having a stepwise concentration of a buffer;
c) passing the elongate body through a plurality of conduits to wash the elongate body, the plurality of conduits comprising a liquid input port and a liquid outlet port, wherein the plurality of conduits have a stepwise gradient of a buffer;

Reverse phase chromatography: a separation is based on an interaction of compounds with a lipophilic stationary phase and a polar mobile phase.

In methods of reverse phase chromatography according to the present invention the method of the present invention may comprise:
a) passing an elongate body through a plurality of conduits to load the elongate body with a target compound, the plurality of conduits comprising a liquid input port and a liquid outlet port; the plurality of conduits being configured such that the liquid contacts the elongate body;
b) passing the elongate body through a plurality of conduits to elute the target compounds, the plurality of conduits comprising a liquid input port and a liquid outlet port; the plurality of conduits being configured such that the liquid contacts the elongate body, the plurality of conduits have a stepwise concentration of a solvent or buffer;
c) passing the elongate body through a plurality of conduits to wash the elongate body, the plurality of conduits comprising a liquid input port and a liquid outlet port, wherein the plurality of conduits have a stepwise gradient of a solvent or buffer;

Hydrophilic interaction liquid chromatography (HILIC): uses polar stationary phases and non-polar, aprotic solvents (more rarely protic solvents like alcohols), with an addition of water-buffers to control the pH and thus modulate retention. The mechanism of the separation is believed to be a combination of hydrophilic partitioning, hydrogen bonding, electrostatic interactions, and van der Waals interactions, but it is not yet fully understood.

In methods of hydrophilic interaction liquid chromatography the method of the present invention may comprise:
a) passing an elongate body through a plurality of conduits to load the elongate body with a target compound, the plurality of conduits comprising a liquid input port and a liquid outlet port; the plurality of conduits being configured such that the liquid contacts the elongate body;
b) passing the elongate body through a plurality of conduits to elute the target compounds, the plurality of conduits comprising a liquid input port and a liquid outlet port; the plurality of conduits being configured such that the liquid contacts the elongate body, the plurality of conduits have a stepwise concentration of a buffer;
c) passing the elongate body through a plurality of conduits to wash the elongate body, the plurality of conduits comprising a liquid input port and a liquid outlet port, wherein the plurality of conduits have a stepwise gradient of a buffer;

Normal phase chromatography: a separation is based on the interaction of compounds with a polar station and a non-polar mobile phase.

In methods of normal phase chromatography the method of the present invention may comprise:
a) passing an elongate body through a plurality of conduits to load the elongate body with a target compound, the plurality of conduits comprising a liquid input port and a liquid outlet port; the plurality of conduits being configured such that the liquid contacts the elongate body;
b) passing the elongate body through a plurality of conduits to elute the target compound, the plurality of conduits comprising a liquid input port and a liquid outlet port, wherein the plurality of conduits have a stepwise gradient of a solvent.

Generally in the methods of chromatography set out above there is a step in which a buffer or solvent combination comprising decreasing or increasing concentration is implemented. In such steps the elongate body may be passed through a plurality of sequential conduits, each of the sequential conduits containing a liquid having a stepped concentration of an active component. For example, the plurality of sequential conduits may each have a concentration of an active component a fixed amount more or less than the immediately preceding conduit in the sequence. For example, the fixed amount may be 10% such that each conduit in the sequence has a concentration 10% less than the immediately preceding conduit from an initial high concentration in a first conduit to a final low concentration in a final conduit or each conduit in the sequence may have a concentration 10% more than the immediately preceding conduit from an initial low concentration in a first conduit to a final high concentration with a final conduit. The use of such gradients has been found to be advantageous in chromatography methods in which removal of a compound has been found to be difficult.

In methods of the present invention passing the elongate body through the conduit or plurality of conduits may act to remove the chemical entity from the liquid. In affinity chromatography the chemical entity becomes associated (e.g. non-covalently bonded) with the affinity entity that is attached to the elongate body, thus removing the chemical entity from the liquid.

It may be that the elongate body and/or the liquid is subjected to sonication (e.g. ultrasound) as it passes through a conduit. It may be that the elongate body and/or the liquid is agitated as it passes through a conduit.

It may be that the elongate body is passed through a plurality of the conduits. Where the elongate body is passed through a plurality of the conduits, it may be that the liquid is likewise passed through a plurality of the conduits. It may be that the liquid is passed through the plurality of the conduits in the opposite direction to the elongate body. Alternatively, it may be that the liquid is supplied separately to each conduit. It may be that the liquid is supplied separately to each conduit from a single liquid source. It may be that the liquid is supplied separately to each conduit from a plurality of liquid sources. The liquid supplied by each of the plurality of liquid sources may differ, e.g. the concentration of a given solvent or solution in the liquid may vary, this is particularly relevant if a elongate body is passed through a plurality of conduits with a stepwise gradient of a buffer or active gradient.

It may be that step b) of a method of affinity chromatography according to the present invention comprises passing the elongate body through a wash conduit, the wash conduit comprising a wash liquid input port and a wash liquid outlet port; wherein a wash liquid passes along the wash conduit from the wash liquid input port to the wash liquid output port in the opposite direction to the elongate body, the wash conduit being configured such that the wash liquid contacts the elongate body. In affinity chromatography passing the elongate body through a wash conduit removes the products present on the elongate body having lower affinity for the affinity entity than the chemical entity. The chemical entity remains associated with (e.g. bound to) the affinity entity, whilst any other products that were present in the initial liquid are washed off. The products having lower affinity for the affinity entity than the chemical entity will typically be present in (e.g. dissolved in) the wash liquid that is recovered from the wash liquid output port.

It may be that the elongate body and/or the wash liquid is subjected to sonication (e.g. ultrasound) as it passes through the wash conduit. It may be that the elongate body and/or the wash liquid is agitated as it passes through the wash conduit.

It may be that the elongate body is passed through a plurality of the wash conduits. Where the elongate body is passed through a plurality of the wash conduits, it may be that the wash liquid is likewise passed through a plurality of the wash conduits. It may be that the wash liquid is passed through the plurality of the wash conduits in the opposite direction to the elongate body. Alternatively, it may be that the wash liquid is supplied separately to each wash conduit. It may be that the wash liquid is supplied separately to each wash conduit from a single wash liquid source. It may be that the wash liquid is supplied separately to each wash conduit from a plurality of wash liquid sources. The wash liquid supplied by each of the plurality of wash liquid sources may differ, e.g. the concentration of a given reagent in the respective wash liquids may vary.

A method of affinity chromatography according to the present invention may further comprise step c) recovering the chemical entity from the elongate body. This step might be particularly useful when the method is a method of affinity chromatography and the desired product is, for example, a protein, a nucleic acid, an antibody, a peptide, a glycopeptide, a glycoprotein or an oligosaccharide.

It may be that step c) comprises passing the elongate body through a displacement conduit, the displacement conduit comprising a displacement liquid input port and a displacement liquid outlet port; wherein a displacement liquid passes along the displacement conduit from the displacement liquid input port to the displacement liquid output port in the opposite direction to the elongate body, the displacement conduit being configured such that the displacement liquid contacts the elongate body. Passing the elongate body through the displacement conduit, displaces the chemical entity from the affinity entity. The chemical entity will typically be present in (e.g. dissolved in) the displacement liquid that is recovered from the displacement liquid output port.

It may be that the elongate body and/or the displacement liquid is subjected to sonication (e.g. ultrasound) as it passes through the displacement conduit. It may be that the elongate body and/or the displacement liquid is agitated as it passes through the displacement conduit.

It may be that the elongate body is passed through a plurality of the displacement conduits. Where the elongate body is passed through a plurality of the displacement conduits, it may be that the displacement liquid is likewise passed through a plurality of the displacement conduits. It may be that the displacement liquid is passed through the plurality of the displacement conduits in the opposite direction to the elongate body. Alternatively, it may be that the displacement liquid is supplied separately to each displacement conduit. It may be that the displacement liquid is supplied separately to each displacement conduit from a single displacement liquid source. It may be that the displacement liquid is supplied separately to each displacement conduit from a plurality of displacement liquid sources. The displacement liquid supplied by each of the plurality of displacement liquid sources may differ, e.g. the concentration of a given reagent in the respective displacement liquids may vary.

It may be that a method of affinity chromatography according to the present invention further comprises step d) recovering the chemical entity from the displacement liquid that is recovered from the displacement liquid output port. This may be achieved by extraction of the displacement liquid that is recovered from the displacement liquid output port. It may be achieved by performing chromatography on the displacement liquid that is recovered from the displacement liquid output port. It may be achieved by removing any volatile solvent present in the displacement liquid that is recovered from the displacement liquid output port, e.g. by heating and/or subjecting to a vacuum.

If the method is affinity chromatography it may be that the method further comprises step e) recovering the products having lower affinity from the wash liquid, e.g. the wash liquid that is recovered from the wash liquid output port. This step might be particularly useful when the chemical entity is, for example, an endotoxin and the desired product is one of the products having lower affinity than the endotoxin for the affinity entity. This may be achieved by extraction of the wash liquid comprising the products which a liquid for which the products have a greater affinity than they do for the wash liquid. It may be achieved by chromatography wash liquid comprising the products. It may be achieved by removing any volatile solvent present in the wash liquid from the products, e.g. by heating and/or subjecting to a vacuum.

By using a multistage continuous process each chromatography stage can be performed in dedicated apparatus(es) optimized for the flow rates and conditions required for each stage. Thus the number of conduits can be selected such that for example a loading stage could use a longer series of channels to give a longer residence time, and would allow the concentration gradient effect to be fully utilized.

It may be that the elongate body is passed through a plurality of conduits for any or all stages of a method of chromatography according to the present invention.

If the method is affinity chromatography the method may further comprise: step f) regenerating the affinity entity. It may be that step f) comprises passing the elongate body liquid through a regeneration conduit, the regeneration conduit comprising a regeneration liquid input port and a regeneration liquid outlet port; wherein a regeneration liquid passes along the regeneration conduit from the regeneration liquid input port to the regeneration liquid output port in the opposite direction to the elongate body, the regeneration conduit being configured such that the regeneration liquid contacts the elongate body.

It may be that the elongate body and/or the regeneration liquid is subjected to sonication (e.g. ultrasound) as it passes through the regeneration conduit. It may be that the elongate body and/or the regeneration liquid is agitated as it passes through the regeneration conduit.

It may be that the elongate body is passed through a plurality of the regeneration conduits. Where the regeneration body is passed through a plurality of the regeneration conduits, it may be that the regeneration liquid is likewise passed through a plurality of the regeneration conduits. It may be that the regeneration liquid is passed through the plurality of the regeneration conduits in the opposite direction to the elongate body. Alternatively, it may be that the regeneration liquid is supplied separately to each regeneration conduit. It may be that the regeneration liquid is supplied separately to each regeneration conduit from a single regeneration liquid source. It may be that the regeneration liquid is supplied separately to each regeneration conduit from a plurality of regeneration liquid sources. The regeneration liquid supplied by each of the plurality of regeneration liquid sources may differ, e.g. the concentration of a given reagent in the respective regeneration liquids may vary.

During each step of a method according to the present invention, therefore, the elongate body moves or is able to move; for example the movement of the solid phase body may be a movement which would for practical purposes be considered continuous (including continuous movement driven by a stepper motor, which in fact rotates in high frequency steps). In some embodiments, the solid phase body is stationary during performance of a step and then moved on to another apparatus to be subjected to another step. In other embodiments, the solid phase body moves intermittently during performance of a step. The fluid phase flows during at least part of a step and it may flow continuously. Thus, the invention includes embodiments in which the solid phase body is contacted with, e.g. surrounded by, a stream of liquid during part or all of a step. A fluid may flow continuously during a step but in some embodiments fluid flow is discontinuous. In many embodiments, both the solid phase body and the fluid phase move continuously between the beginning and the end of a step.

### Affinity Chromatography

In methods of the present invention that are affinity chromatography methods can be applied in combination with known affinity chromatography techniques. Thus, the options available for the affinity moiety, the means by which it is attached to the elongate body, the wash solution and the means by which the chemical entity can be recovered from the elongate body will be familiar to the skilled person and will be selected based on the identity of the chemical entity. Details can be found in review articles such as Nature Biotechnology, vol 5, December 1987—Large Scale Affinity Chromatography by Yannis D Clonis and Methods; 116 (2017); 84-94—Affinity Chromatography: A versatile technique for antibody purification by S Arora, V Saxena and B V Ayyar, which are incorporated herein in their entirety.

### Chemical Entity in Affinity Chromatography

The chemical entity may comprise a protein, a nucleic acid, an antibody, a peptide, a glycopeptide, a polysaccharide, an alkaloid, a glycoprotein or an

oligosaccharide. The chemical entity may comprise a protein. The chemical entity may be a protein. The chemical entity may comprise an antibody. The chemical entity may be an antibody. The chemical entity may be an alkaloid.

The chemical entity will typically be unchanged by the process. Thus, the species that is recovered from the methods of the invention (e.g. following a displacement step) will typically be the same (i.e. have the same chemical structure) as the species that was present in the initial liquid. The liquid from which the chemical entity is to be isolated may be a mammalian milk, serum, a fermentation broth, ascetic fluid, hybridoma, a lysate of hybridoma cells, lysate of plant cells, lysate of mammalian cells, lysate of fungal cells, lysate of bacterial cells, lysate of yeast cells, an extract of plant material, an extract of fungal material, a ribosome-produced protein.

### Affinity Entity in Affinity Chromatography

The affinity entity may be attached to the elongate body via covalent bonding. The affinity entity may be attached to the elongate body via non-covalent bonds to functional linker groups that are themselves attached to the elongate body via covalent bonding.

The affinity entity may be attached to the elongate body using a linker group. The linker group is typically a group derived from the reaction of a hydroxyl group on a polysaccharide on the elongate body with a linker agent and reaction of the subsequent species with the affinity entity. Illustrative linker agents include: 1,4-butanediol diglycidyl ether, cyanogen bromide, 1-carbonyldiimidazole, 1,3-dibromo-2-propanol, 2,3-dibromopropanol, divinylsulfone, epichlorhydrin, glyceraldehyde and tresyl chloride.

The affinity entity will be selected based on the chemical entity that is being isolated from the liquid. The affinity entity should have a higher affinity for the chemical entity than for any of the other products that are present in the liquid from which the chemical entity is to be isolated. The affinity entity may comprise a reactive dye.

The affinity entity may comprise an amino acid. The affinity entity comprise an antibody, peptide, protein, nucleic acid, small molecules, lectin, antigen or anti-antibody

Illustrative proteins include protein A, protein G, protein L. Illustrative lectins include concanavalin A, wheat germ agglutinin, mannan-binding protein and jacalin.

The affinity entity may comprise a metal ion, e.g. a transition metal ion. Illustrative metal ions include Co²⁺, Cu²⁺, Fe²⁺, Ni²⁺ and Zn²⁺. Where the affinity entity comprises a metal ion, the affinity entity will comprise a chelating entity covalently attached to the elongate member (e.g. solid phase particles comprised within the elongate member). The chelating entity will chelate the metal ion. Illustrative chelating entities include phenylalanine tetrazole, iminodiacetic acid, nitrilotriacetic acid and tris(carboxymethyl)ethylene diamine.

The affinity entity may comprise a thioether-substituted organic sulfone (e.g. Thiosorb, T-gel).

The affinity entity may comprise hydroxyapatite.

The association between the affinity entity and the chemical entity is typically reversible. It may be that no covalent bonds are formed between the affinity entity and the chemical entity during step a). The association between the affinity entity and the chemical entity may be hydrogen bonding, dative bonding, ionic bonding, Van der Waals forces or a mixture thereof.

The affinity entity may be pores of a specified size. The pores may simply exclude all products having a size greater than the specified size (the chemical entity having a size below that size). Alternatively, the pores may have a greater affinity for products having a size within a specified range (the chemical entity having a size within that range). Thus, the elongate body may comprise a porous material having pores of the specified size. Examples include porous copolymers, e.g. polystyrene-divinylbenzene. It may be that the affinity entity is not pores of a specified size.

### Wash Step in Affinity Chromatography

The wash step b) removes any products having lower affinity than the chemical entity for the affinity entity. These products will typically be impurities in the liquid from which the chemical entity is to be isolated that have become absorbed or otherwise associated with the elongate body. The nature of these impurities will depend on how the liquid has been obtained.

Step b) may comprises contacting the elongate solid phase with a wash solution. The wash solution may be water or an aqueous solution. Step b) may comprise contacting the solid phase with a wash solution, the wash solution comprising a buffer. Additionally or alternatively, the wash solution may comprise a salt (e.g. NaCl or MgCh). Additionally or alternatively, the wash solution may comprise a detergent.

### Displacement Step in Affinity Chromatography

In step c) the chemical entity is recovered from the elongate body, typically by displacing the chemical entity from the affinity moiety. Step c) may comprises contacting the elongate solid phase with a displacement solution.

The displacement solution may be an aqueous solution. It may be a buffer solution (where the wash step b) also used a buffer solution, the buffer solution in step c) will typically be at a different pH to the buffer used in step b)). Additionally or alternatively, the displacement solution may comprise a salt (e.g. LiCl, NaCl or MgCl. The displacement solution may comprise guanidine and/or urea.

The displacement solution may contain an organic solvent.

The displacement solution may comprise an organic chemical having a sufficiently high affinity for the affinity entity to displace the chemical entity. The displacement solution may comprise imidazole. This is particularly useful where the affinity entity comprises a metal ion.

The displacement solution may comprise a peptide, protein, antigen, lectin, antibody that has a higher affinity for the affinity moiety than the chemical entity.

For affinity chromatography, suitable displacement solutions may be used depending on the type of compound and affinity element of interest.

For example, the buffer solution may be:
i) Buffer solutions which can be tuned to a specific pH of interest such as, but not limited to glycine hydrochloride buffer, which offers an acidic pH, or ammonium hydroxide buffer, which offers a basic pH;
ii) Buffers and solutions with high ionic strength, obtained with high salt concentrations, such as but not limited to magnesium chloride or sodium thiocyanate.
iii) Solutions containing denaturing substances such as but not limited to urea and sodium dodecyl sulfate.
iv) Solutions containing organic solvents, such as but not limited to ethylene glycol or dioxane.
v) Solutions with specific competitors such as, but not limited to, imidazole and glutathione in appropriate concentrations.

### The Elongate Body in Affinity Chromatography

The elongate body may comprise a polysaccharide, e.g. a cellulose or agarose material which may be cross-linked. Polysaccharide materials comprise hydroxyl groups to which the affinity entity may be attached, either directly or indirectly via a linker group.

The elongate body may comprise a copolymer, e.g. polystyrene-divinylbenzene. Such materials may be porous materials where the affinity moiety is a pore of a specified size. Such materials may have an affinity entity attached to them, e.g. via covalent bonding.

### The Elongate Body Generally

The elongate body may comprise an elongate body portion and a plurality of enclosures distributed along the length of the elongate body portion, the enclosures being formed of a material comprising a chemically inert mesh; and within each enclosure, a plurality of solid phase particles wherein the affinity entity is attached to the particles; wherein the size of the holes in the mesh and the size distribution of the solid phase particles are selected such that the particles do not pass through the mesh.

The term chemically inert is used herein to mean a polymer that is chemically unreactive and/or insoluble in the conditions of the processes of the method.

The mesh may be a polymeric mesh, i.e. one formed of a chemically inert polymer. Polymers such as polypropylene, polyethylene, polyester, polyamide (e.g. aramid), and silk could be suitable. The polymer may be a fluorinated polymer or copolymer. The polymer may be polytetrafluoroethylene (PTFE) or ethylene tetrafluoroethylene copolymer (ETFE). The polymer may be ETFE. The polymer may be aramid. The polymer may be polyether ether ketone (PEEK).

Alternatively, the mesh may be formed of a material selected from glass fibers, titanium, stainless steel, carbon fiber, graphene.

It may be that the material is formed of the mesh, e.g. the polymeric mesh.

The pores of the mesh are typically large enough to allow the liquid and the chemical entity to pass unimpeded or substantially unimpeded through the porous bag or tube to the particles inside. The pore size of the porous material may be less than 150 μm, less than 100 μm, less than 50 μm or less than 25 μm. In certain embodiments, the pore size is in the range from 30 to 80 μm, e.g. in the range from 45 to 65 μm.

It may be that the elongate body and the enclosures are formed of the same material. It may be that the elongate solid phase body comprises two elongate strips of the material connected together so as to form the elongate body portion and the plurality of enclosures. The two strips of material may be connected to each other continuously along both longitudinal sides of the elongate body and periodically connected continuously across the transverse width of the elongate body to form the enclosures. The two strips of material may form part of the same piece of material that is folded along a first longitudinal side of the elongate body. The two strips of material may form part of the same piece of material that is tubular, e.g. one formed on a circular loom.

Where the material is a polymeric mesh, it may be welded continuously along both longitudinal sides of the elongate body and periodically welded continuously across the transverse width of the elongate body to form the enclosures. Where the two strips of elongate material form part of the same piece of material that is folded along a first longitudinal side of the elongate body, the material may be welded continuously along a second longitudinal side of the elongate body and periodically welded continuously across the transverse width of the elongate body to form the enclosures.

Alternatively, the material may be sewn, stapled or bonded continuously along both longitudinal sides of the elongate body and sewn, stapled or bonded continuously across the transverse width of the elongate body to form the enclosures. Where the two strips of elongate material form part of the same piece of material that is folded along a first longitudinal side of the elongate body, the material may be sewn, stapled or bonded continuously along a second longitudinal side of the elongate body and periodically sewn or bonded continuously across the transverse width of the elongate body to form the enclosures.

Where the two strips of elongate material form part of the same piece of material that is tubular, the material may be welded, sewn, stapled or bonded continuously across the transverse width of the elongate body to form the enclosures.

The seams or joins along the longitudinal side or sides of the elongate body may be suitable for providing purchase for a roller, allowing the roller to guide and or drive the elongate material. Thus, the seams or joins along the longitudinal side or sides of the elongate body may comprise sprocket holes or raised or depressed lumps or ridges.

The seams or joins may have a width in the range from 2 mm to 10 mm, e.g. in the range from 3 mm to 5 mm.

The solid phase particles may have a diameter of from 45 to 180 μm, for example from 60 to 180 μm, or from 60 to 100 μm or from 150 to 180 μm or any other suitable size. The solid phase particles may be nanoparticles, e.g. nanoparticles supported on an inert solid phase that has the above mentioned diameters or nanoparticles in the form of aggregates.

The elongate body may have a length greater than 500 mm. The elongate body may have a length greater than 1000 mm. The width of the elongate body is typically in the range 5 mm to 100 mm, e.g. 5 to 30 mm. The width of the elongate body may be in the range 15 mm to 25 mm.

The elongate body may be continuous, i.e. it may be in the form of a loop.

The solid phase particles are typically packed in such a way as to allow free movement. This is of benefit when using ultrasound to increase the mixing of a liquid phase and the particles. Thus, it may be that the enclosures are each only partially filled with solid phase particles. It may be that the enclosure contains less than 90% (e.g. less than 80% or less than 70%) of the maximum amount of particles that the enclosure could hold.

The enclosures may have substantially the same transverse width (the dimension of the enclosure in a direction transverse to the elongate body) as the elongate body.

There will typically be at least one seam and/or join that runs along the longitudinal edge or edges of the elongate body, the seam or join forming the enclosure. The term ‘substantially’ in this instance means that the transverse width of the elongate body will be the transverse width of the enclosure plus the sum of the widths of the seam(s) and/or join(s).

The enclosures may have a longitudinal length (the dimension of the enclosure in a direction longitudinal to the elongate body) of between 5 and 50 mm. The enclosures may have a longitudinal length (the dimension of the enclosure in a direction longitudinal to the elongate body) of between 15 and 25 mm.

The enclosures may all be the same size. Alternatively, some enclosures may be smaller than others. This would be useful, for example, for obtaining samples of the solid phase beads at various positions along the elongate membrane, e.g. during operation. It may be there are two groups of enclosures and that the enclosures in each group are the same size as the other enclosures in that group. It may be that the enclosures in a first group are smaller than those in a second group. It may be that less than 20% of the total numbers of enclosures are in the first group. It may be that less than 10% of the enclosures are in the first group. The enclosures of the first group may be situated periodically along the elongate solid phase body.

The solid phase particles are suitable for chromatography.

The solid phase particles may be spherical. The solid phase particles may be cylindrical. The solid phase particles may be fibers. The solid phase beads may be irregularly shaped.

The solid phase particles may be polymer particles.

The solid phase particles may be a synthetic polymer. Illustrative examples include polystyrene, polymethacrylate (e.g. Separon HEMA®) or a poly acrylamide (e.g. Bio-Gel®).

The solid phase particles may be formed of a natural polymer, typically a polysaccharide material, for example cellulose, dextran or agarose, that may be cross-linked. Illustrative materials include Sephadex®, Superdex®, Sepharose®, Macrosorb®, Trisacryl® and Matrix Cellufine®.

Alternatively, the solid phase particles may be inorganic, e.g. a material selected from controlled porosity glass, porous silica, glass fiber and TiO₂.

In affinity chromatography the affinity entity may be attached to the solid phase particles via covalent bonding.

In an aspect of the invention is provided an elongate body for affinity chromatography and attached to the elongate body is an affinity entity. The elongate body and the affinity entity may have any of the features described above for the first aspect of the invention.

### Apparatus

The apparatus may be an apparatus as described in WO2017/122009, incorporated herein by reference in its entirety as if set forth herein.

A chromatography method performed on a system comprising:
an affinity module, the affinity module comprising the conduit; and
a first service module operably connected to a first side of an affinity module, the first service module for supplying and/or receiving the liquid to and/or from the affinity module;
wherein the system is configured for passing the solid phase through the affinity module, via the conduit.

The system may comprise two or more affinity modules, provided in series, such that the solid phase may pass through consecutive affinity modules. It may be that the system is configured such that the liquid also passes through the consecutive affinity modules. It may be that the system is configured such that the liquid passes through the consecutive affinity modules in the opposite direction to the elongate body. It may be that each service module that supplies liquid to the affinity modules is configured to supply liquid from the same liquid source. It may be that two service modules that each supply liquid to the affinity modules are configured to supply liquid from different liquid sources.

The system may further comprise:
a wash module, the wash module comprising the wash conduit; and
a second service module operably connected to a first side of a wash module, the second service module for supplying and/or receiving the wash liquid to and/or from the wash module;
wherein the system is configured for passing the solid phase through the wash module, via the wash conduit.

The system may comprise two or more wash modules, provided in series, such that the solid phase may pass through consecutive wash modules. It may be that the system is configured such that the wash liquid also passes through the consecutive wash modules.

It may be that the system is configured such that the wash liquid passes through the consecutive wash modules in the opposite direction to the elongate body. It may be that each service module that supplies wash liquid to the wash modules is configured to supply wash liquid from the same wash liquid source. It may be that two service modules that each supply wash liquid to the wash modules are configured to supply wash liquid from different wash liquid sources.

A system according to the present invention may further comprise:
a displacement module, the displacement module comprising the displacement conduit; and
a third service module operably connected to a first side of a displacement module, the third service module for supplying and/or receiving the displacement liquid to and/or from the displacement module;
wherein the system is configured for passing the solid phase through the displacement module, via the displacement conduit.

The system may comprise two or more displacement modules, provided in series, such that the solid phase may pass through consecutive displacement modules. It may be that the system is configured such that the displacement liquid also passes through the consecutive displacement modules. It may be that the system is configured such that the displacement liquid passes through the consecutive displacement modules in the opposite direction to the elongate body. It may be that each service module that supplies displacement liquid to the displacement modules is configured to supply displacement liquid from the same displacement liquid source. It may be that two service modules that each supply displacement liquid to the displacement modules are configured to supply displacement liquid from different displacement liquid sources.

It may be that the modules (including any affinity modules, wash modules, displacement modules and service modules), are all configured to releasably connect to adjacent modules.

It may be that the first side and further side of the one or more affinity, wash and/or displacement module(s) are each a mating face, and the respective service module has a mating face that is connectable with a respective mating face of each affinity, wash and/or displacement module. It may be that the affinity, wash and/or displacement module(s) is releasably connected to the respective service module.

It may be that the conduit or each conduit (including wash conduits or displacement conduits) comprises a solid phase input port and a solid phase output port. Thus, it may be that one of the solid phase input port and solid phase output port is provided in the side of the affinity, wash or displacement module, and the other of the solid phase input port and solid phase output port is provided in the other side of the affinity, wash and/or displacement module.

It may be that the fluid input port(s) and fluid outlet port(s) are provided on the sides of the affinity, wash and/or displacement module(s) so as to releasably connect and seal to corresponding ports on adjacent modules.

It may be that the system further comprises a holding element, the affinity, wash and/or displacement module(s) and respective service modules being connectable to the holding element.

The system may further comprise one or more service ducting module(s), the affinity, wash and/or displacement module(s) and respective service module(s) connectable to the service ducting module(s), the service ducting module(s) for providing services to the service module(s).

The system may further comprise a solid phase delivery module configured to connect in series with the first service module or affinity module, the solid phase delivery module comprising a source of the solid phase.

It may be that the affinity, wash and/or displacement module(s) comprise a lid portion and a body portion, the lid portion removeable from the body portion so as to give access to the respective conduit, wash conduit and/or displacement conduit.

It may be that the conduit(s) comprise a chamber, and the affinity, wash and/or displacement module(s) comprise a projection that is insertable at least partly into the chamber, the chamber and projection thereby forming a passageway as part of the conduit. The projection may comprise a roller over which the solid phase may pass.

Modules in alternative chromatography methods. In alternative chromatography methods the modules of the apparatus may be comprised in the same manner as the modules of an affinity chromatography. The modules may comprise any of the features set out above in relation to affinity chromatography.

The system may further comprise a drive train element for moving the solid phase through the system.

The service module(s) may comprise a fluid conduit for connecting with the fluid input port of the respective affinity, wash and/or displacement module(s). The service module(s) may comprise a fluid phase supply or removal element, and the system may further comprise a further service module comprising an electrical power supply element. The service module(s) may further comprise a controller or be connected to a controller, the controller being configured to control at least one of the speed of movement of the solid phase, the speed of movement of the fluid phase, and a process modifying device responsive to one or more sensors. In this instant, sensors include spectrometers or other instruments that can obtain data collected from the fluid phase as it enters the service module.

These and other objects, features and advantages of the present invention will become more apparent upon reading the following specification in conjunction with the accompanying drawing FIGURE.

### BRIEF DESCRIPTION OF THE DRAWING

The accompanying FIGURE, which is incorporated in and constitutes a part of this specification, illustrates several aspects described below.

The sole FIGURE is a depiction of an illustrative apparatus that can be used to carry out the methods of the invention. It is the apparatus used to carry out Example 2. It is intended as illustrative of the concept of the apparatus only and the apparatus may be modified appropriately by the skilled person to implement any specific embodiment of the invention. For example, it will be understood that if a method according to the present invention requires more adjacent conduits and/or more steps then the skilled person would modify the apparatus appropriately to have more conduits and/or steps.

### DETAIL DESCRIPTION OF THE INVENTION

As used in this specification, the term ‘remove’ may mean entirely remove or it may mean partially remove. Thus, it may mean that greater than 25% of the chemical entity is removed from the liquid. It may mean that greater than 75% of the chemical entity is removed from the liquid. It may mean that greater than 90% of the chemical entity is removed from the liquid. It may mean that greater than 95% of the chemical entity is removed from the liquid.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments.

The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1—Preparation of Immobilized Metal Affinity Chromatography (I MAC) Ribbon

1. Prepare a saturated solution of disodium iminodiacetate in DMF/water 12:5 v/v.
2. Unwind cotton tape (22 mm×1 mm×6 m) from spool and soak in 20 mlg-1 of 0.1% v/v detergent in water at 80 C for 1 hour.
3. Wash the tape: 10 min of manual mixing with a glass, using 20 mlg-1 of distilled water at 80 C. Repeat five times. Dry the tape at room temperature until touch dry.
4. Dry the cotton by placing into an airtight bottle with DMF and 10% v/v 4 A
molecular sieves for 48 hours.
5. Soak DMF-dried cotton tape in anhydrous DMF at 80 C for one hour.
6. Prepare a solution of phosphorous oxychloride (POC) in DMF by slowly
adding 24 ml of POCL3 to 1 liter of anhydrous DMF.
7. Heat the solution to 90 C using a water bath (exclude moisture from DMF solution!) and add the cotton tape to the solution and continue to heat at 90 C for 30 mins.
8. Remove the tape (should be brown colored) from the DMF/POCh solution and wash twice with DMF.
9. Wash the tape 2× with water.
10. Wash the tape with 5% w/v aqueous NaOH solution.
11. Wash the tape 2× with water.
12. Wash the tape with 5% v/v aqueous acetic acid solution.
13. Wash the tape 2× with water.
14. Place the chlorinated cotton tape into a flask equipped with a reflux condenser, along with an excess of saturated disodium iminodiacetate solution.
15. Heat the solution to 105-110 C for 150 mins with cold water flowing through the condenser.
16. Wash the cotton tape 5× with distilled water.
17. Dry the tape at room temperature for 48 hours or until touch dry.

### Example 2—Performing Continuous Affinity Chromatography Purification of Lactalbumin From Milk

Skimmed milk was used as a simulant for fermented broth due to milk being very consistent in composition and also having a high concentration of a water soluble protein.

A fermented broth may also need ultrasonic treatment (to disintegrate cells and release proteins into solution) and filtration prior to affinity chromatography.

The apparatus 1 used in example 2 is shown in the sole FIGURE. The cotton tape 2 was passed sequentially through three conduits 3, 4, 5. The conduits were formed from four PTFE blocks 9 that are shaped so as to provide three chambers. Into each chamber was inserted three inserts 6, each insert having at its end a roller 7. The inserts fit into the chamber so as to form three u-shaped conduits 3, 4, 5. The respective liquids flow into each conduit 3, 4, 5 via an inlet (not shown) just below the exit points 10 of the cotton tape 2 into the respective conduits. The respective liquids flow out of each conduit 3, 4, 5 via an inlet (not shown) just below the entry points 11 of the cotton tape 2 into the respective conduits. Rollers 8 were also provided before and after the conduits to help the tape to pass through the apparatus. The functionalized cotton tape 2 is placed into an excess of 1 M aqueous copper sulphate solution and allowed to stand for 30 mins.

The cotton tape 2 is then removed from the solution and washed with water until the run off is colorless.

Then the tape is passed through the conduit 3, 4, 5 with the first conduit 3 containing a flow of clarified milk whey, the second conduit 4 (the wash conduit) containing a flow of Buffer A (pH 7 phosphate buffer, 20 mM tris(hydroxymethyl)aminomethane, 0.5M NaCl), and the third channel 5 (the displacement conduit) containing a flow of Buffer B (pH 7 phosphate buffer, 20 mM imidazole, 0.5M NaCl)

The flow of Buffer B and lactalbumin leaving the apparatus 1 is collected.

Set out below are further examples of alternative chromatography methods. In each of these examples the same elongate body is utilized. The elongate body comprises a polymeric mesh, welded continuously along both longitudinal sides of the elongate body and periodically welded continuously across the transverse width of the elongate body to form enclosures. The enclosures of the elongate body are filled with material based on the chromatography process being carried out as set out in the description below.

### Example 3: Ion Exchange Chromatography

The elongate body is loaded with a strong cation exchange resin and joined head to tail to form an elongate loop. The elongate body travels through five steps, where each step consists of a plurality of conduits before returning into the first step in a loop. Within each step a liquid chemical flows from an inlet port to an exit port in a counter flow to the elongate body motion. The plurality of conduits of each step contains a gradient of the liquid concentration, such that each adjacent conduit contains a different concentration of solution or buffer to the immediately adjacent conduit or conduits. Each step performs a process step as described below.

A first step performs the immobilization of the target compound. His-tagged hDM2 (17-125), previously fractionated via Ni affinity, is diluted with a 20 mM phosphate buffer at pH=6.74 containing 1 mM EDTA and 1 mM DTT and is the liquid is fed into the system.

In a second step the elongate body now carrying the immobilized protein is washed with a counter flow of 20 mM phosphate buffer at pH-6.74 containing 1 mM EDTA and 1 mM DTT.

In a third step, elution, the protein is collected with a stepwise gradient of a buffer (20 mM phosphate buffer at pH=6.74 containing 1 mM EDTA and 1 mM DTT) with increasing concentration of sodium chloride, 10 steps, 0.1 M increase at each step. That is, elongate body is passed through conduits, each of which has a concentration of sodium chloride that is increased by 0.1M. The outflow of the conduits with pure protein is directed to collection, while the less pure fractions could be collected and fed into a new system for further recovery.

In a fourth step, cleaning, the resin of the elongate body is extensively washed with 20 mM phosphate buffer at pH=6.74 containing 1 mM EDTA and 1 mM DTT containing 1 M sodium chloride.

In a fifth step, equilibration, the resin of the elongate body is washed with the initial buffer, 20 mM phosphate buffer at pH=6.74 containing 1 mM EDTA and 1 mM DTT. The elongate body now exits the final step and loops back to the first step for a new cycle, forming a continuous process.

### Example 4: Hydrophobic Interaction Chromatography

The elongate body is loaded with a HIC benzyl resin and joined head to tail to form an elongate loop. The elongate body travels through three steps, where each step consists of a plurality of conduits before returning into the first step in a loop. Within each step the liquid chemical flows from an inlet port to an exit port in a counter flow to the elongate body motion. Each step performs a process step as described below.

In a first step, ribonuclease A and chymotrypsinogen are loaded on the resin within the elongate with a 50 mM phosphate buffer at pH 7 containing 1.7 M ammonium sulfate.

In a second step, elution, the proteins are separated by a stepwise gradient of the above buffer (50 mM phosphate buffer at pH 7 containing 1.7 M ammonium sulfate) with decreasing concentration of ammonium sulfate, 10 steps, 0.17 M less at each step. The outflow of the conduits with pure protein is directed to collection, while the less pure fractions are collected and fed into a new system for further recovery.

In a third step, equilibration, the HIC resin is washed with the initial buffer, 50 mM phosphate buffer at pH 7 containing 1.7 M ammonium sulfate. The elongate body now exits the final step and loops back to the first step for a new cycle, forming a continuous process.

### Example 5: Reverse Phase Chromatography

The elongate body is loaded with C18 reverse phase chromatography media and joined head to tail to form an elongate loop. The elongate loop travels through four steps, where each step consists of a plurality of conduits before returning into the first step in a loop. Within each step the liquid chemical flows from an inlet port to an exit port in a counter flow to the elongate motion. Each step performs a process step as described below.

In a first step, a mixture of uracil and amitriptyline hydrochloride dissolved in a 60/40 mix of 20 mM phosphate buffer at pH 7 and MeOH flows counter flow to the elongate body.

In a second step, the ribbon is washed with 60/40 mix of 20 mM phosphate buffer at pH 7 and MeOH.

In a third step, amitriptyline is eluted using the above buffer (60/40 mix of 20 mM phosphate buffer at pH 7 and MeOH) with increasing concentration of MeOH, 6 steps, 10% more at each step, up to 100% MeOH. The outflow of the conduits with amitriptyline is collected, while the less pure fractions are collected and fed into a new system for further recovery.

In a fourth step, equilibration, the ribbon is washed with the initial buffer, 60/40 mix of 20 mM phosphate buffer at pH 7 and MeOH. The elongate body now exits the final step and loops back to the first step for a new cycle, forming a continuous process.

### Example 6: Hydrophilic Interaction Liquid Phase Chromatography

The elongate body is loaded with HILIC-Z media and joined head to tail to form an elongate loop. The elongate body travels through three steps, where each step consists of a plurality of conduits before returning into the first step in a loop. Within each step the liquid chemical flows from an inlet port to an exit port in a counter flow to the elongate body motion. Each step performs a process step as described below.

In a first step, a mixture of arginine and tryptamine dissolved in a 90/10 mix of acetonitrile and 20 mM ammonium acetate containing 5 μM medronic acid at pH 9.3 flows counter current to the elongate body.

In a second step, arginine and tryptamine are eluted using the above buffer (90/10 mix of acetonitrile and 20 mM ammonium acetate containing 5 μM medronic acid at pH 9.3) with decreasing concentration of acetonitrile, 8 steps, 10% less at each step, down to 10/90 ratio The outflow of the conduits with the compounds of interest is collected, while the less pure fractions are collected and fed into a new system for further recovery.

In a fourth step, equilibration, the elongate is washed with the initial buffer, 90/10 mix of acetonitrile and 20 mM ammonium acetate containing 5 μM medronic acid at pH 9.3 flows counter current to the elongate. The elongate body then exits the final step and loops back to the first step for a new cycle, forming a continuous process.

### Example 7: Normal Phase Chromatography

The elongate body is loaded with amorphous silica. The elongate body travels through two steps, where each step consists of a plurality of conduits before exiting the system. Within each step the liquid chemical flows from an inlet port to an exit port in a counter flow to the elongate body motion. Each step performs a process step as described below.

In a first step, a solution of benzoic acid and ethyl benzoate in 40/60 ethyl acetate/hexane flows counter current to the ribbon, which retains the benzoic acid and some ethyl benzoate. The solution containing only ethyl benzoate is recovered as outflow to the system, while the less pure fractions could be collected and fed into a new system for further recovery.

In a second step, additional ethyl benzoate is recovered by washing the elongate with fresh solvent, 40/60 ethyl acetate/hexane, and the solution is recovered at the outflow of the conduits. The elongate body now exits the final step and the process is complete.

### Example 8: Affinity Chromatography with Downstream Ion Exchange Chromatography (IEC)

Two systems are employed to obtain the purification of a protein using a combination of affinity chromatography and ion exchange. The first system uses nickel affinity to isolate His-tagged hDM2 (17-125), which is then refined by feeding the outflow to the ion exchange step, as described below.

In the nickel affinity step, an elongate body is loaded with a strong cation exchange resin and joined head to tail to form an elongate loop. The elongate loop travels through five steps, where each step consists of a plurality of conduits before returning into the first step in a loop. Within each step the liquid chemical flows from an inlet port to an exit port in a counter flow to the elongate body motion. Each step performs a process step as described below.

The first step performs the immobilization of the target compound. A cell lysate in 20 mM Tris-HCl buffer containing 300 mM NaCl and 20 mM imidazole from cell a culture overexpressing His-tagged hDM2 (17-125), is treated by centrifugation to remove all solids and the supernatant is fed into the system.

In the second step the elongated body carrying the immobilized protein is washed with a counter flow of 20 mM Tris-HCl buffer containing 300 mM NaCl and 20 mM imidazole.

In the third step, elution, the protein is collected with a stepwise gradient of 20 mM Tris-HCl buffer containing 300 mM NaCl with increasing concentration of imidazole, 2 steps at 100 mM, 2 steps at 200 mM and 2 steps at 300 mM. The outflow of the conduits with good quality protein is directed to ion exchange chromatography, performed as described in Ion exchange chromatography (IEC) above, while the less pure fractions could be collected and fed into a new system for further recovery.

In the fourth step, cleaning, the resin is extensively washed with 20 mM Tris-HCl buffer containing 300 mM NaCl and 300 mM imidazole.

In the fifth step, equilibration, the resin is washed with the initial buffer, 20 mM Tris-HCl buffer containing 300 mM NaCl and 20 mM imidazole. The elongate body now exits the final step and loops back to the first step for a new cycle, forming a continuous process.

What is claimed is:

1. A method comprising:
passing an elongate body through one or more conduits to remove a chemical entity from a liquid; and
washing the elongate body to remove products other than the chemical entity
wherein:
attached to the elongate body is an affinity entity having an affinity for the chemical entity;
each of the one or more conduits comprises a liquid input port and a liquid outlet port;
the liquid from which the chemical entity is removed passes along the one or more conduits from the liquid input port to the liquid output port in the opposite direction to the elongate body; and
the one or more conduits are configured such that the liquid contacts the elongate body.

2. The method of claim 1 further comprising sonication;
wherein at least one of the elongate body or the liquid is subjected to the sonication as it passes through the one or more conduits.

3. The method of claim 1, wherein:
the elongate body passes through a plurality of the conduits; and
the method further comprises removing a chemical element from the liquid at an outflow of each of the plurality of the conduits.

4. The method of claim 1 further comprising passing a wash liquid along a wash conduit;
wherein:
washing the elongate body comprises passing the elongate body through the wash conduit to remove products present on the elongate body having lower affinity for the affinity entity than the chemical entity;
the wash conduit comprise a wash liquid input port and a wash liquid outlet port;
the wash liquid passes along the wash conduit from the wash liquid input port to the wash liquid output port in the opposite direction to the elongate body; and
the wash conduit is configured such that the wash liquid contacts the elongate body.

5. The method of claim 4 further comprising sonication;
wherein at least one of the elongate body or the wash liquid is subjected to the sonication as it passes through the wash conduit.

6. The method of claim 4, wherein:
the elongate body passes through a plurality of wash conduits; and
the method further comprises removing a chemical element from the wash liquid at an outflow of each of the plurality of the wash conduits.

7. The method of claim 1 further comprising:
recovering the chemical entity from the elongate body.

8. The method of claim 4 further comprising:
recovering the chemical entity from the elongate body; and
passing a displacement liquid along a displacement conduit;
wherein:
recovering the chemical entity from the elongate body comprises passing the elongate body through the displacement conduit to displace the chemical entity;
the displacement conduit comprises a displacement liquid input port and a displacement liquid outlet port;
the displacement liquid passes along the displacement conduit from the displacement liquid input port to the displacement liquid output port in the opposite direction to the elongate body; and
the displacement conduit is configured such that the displacement liquid contacts the elongate body.

9. The method of claim 8 further comprising sonication;
wherein at least one of the elongate body or the displacement liquid is subjected to the sonication as it passes through the displacement conduit.

10. The method of claim 8 further comprising:
recovering the chemical entity from the displacement liquid that is recovered from the displacement liquid output port.

11. The method of claim 8, wherein:
the elongate body passes through a plurality of displacement conduits; and
the method further comprises removing a chemical element from the displacement liquid at an outflow of each of the plurality of the displacement conduits.

12. The method of claim 8, wherein the elongate body passes through a plurality of at least one of the:
conduits;
wash conduits; or
displacement conduits.

13. The method of claim 12, wherein:
the plurality of at least one of the conduits, wash conduits, or displacement conduits comprises at least a set of immediately adjacent such conduits, wash conduits, or displacement conduits through which the elongate body passes; and
the set of immediately adjacent conduits, wash conduits, or displacement conduits are supplied with a different concentration of a solution or a buffer one from the other.

14. The method of claim 12, wherein:
the plurality of at least one of the conduits, wash conduits, or displacement conduits comprises two or more sets of immediately adjacent such conduits, wash conduits, or displacement conduits through which the elongate body passes;
the sets of immediately adjacent conduits, wash conduits, or displacement conduits are supplied with a different concentration of a solution or a buffer varying regularly from a first one conduit, wash conduits or displacement conduit of a first immediately adjacent set to a last one conduit, wash conduits or displacement conduit of a last immediately adjacent set;
the concentration of the solution or the buffer of the first one conduit, wash conduits or displacement conduit is an initial concentration; and
the concentration of the solution or the buffer of the last one conduit, wash conduits or displacement conduit is a final concentration.

15. The method of claim 14, wherein:
the plurality of at least one of the conduits, wash conduits, or displacement conduits comprises a plurality of wash conduits; and
either:
the initial concentration is higher than the final concentration; or
the initial concentration is lower than the final concentration.

16. The method of claim 14, wherein:
the plurality of at least one of the conduits, wash conduits, or displacement conduits comprises a plurality of displacement conduits; and
either:
the initial concentration is higher than the final concentration; or
the initial concentration is lower than the final concentration.

17. The method of claim 12, wherein the plurality of at least one of the conduits, wash conduits, or displacement conduits comprises at least ten of the conduits, wash conduits, or displacement conduits.

18. The method of claim 1, wherein:
the elongate body comprises an elongate body portion and a plurality of enclosures distributed along a length of the elongate body portion;
each enclosure is formed of a material comprising a chemically inert mesh;
the affinity entity is attached to a plurality of solid phase particles within each enclosure; and
the size of holes in the chemically inert mesh and the size distribution of the solid phase particles are selected such that the solid phase particles do not pass through the chemically inert mesh.

19. The method of claim 18, wherein washing the elongate body comprises contacting the solid phase particles with a wash solution comprising a buffer.

20. The method of claim 1 further comprising providing a system comprising:
a displacement module comprising the one or more conduits; and
a first service module operably connected to a first side of an affinity module;
wherein:
the first service module is for supplying and/or receiving the liquid to and/or from the affinity module; and
the system is configured for passing a solid phase through the displacement module via the one or more conduits.
